(19) United States
(12) Patent Application Publication
(10) Pub. No.: US 2021/0025519 A1
(43) Pub. Date: Jan. 28, 2021

(54) Valve with Grooved Sleeve

(71) Applicant: Kerr Machine Co., Sulphur, OK (US)

(72) Inventors: Mark S. Nowell, Ardmore, OK (US); Micheal Cole Thomas, Ardmore, OK (US); Christopher Todd Barnett, Stratford, OK (US); Brandon Stephen Nowell, Ardmore, OK (US)

(21) Appl. No.: 17/068,126

(22) Filed: Oct. 12, 2020

Related U.S. Application Data
(63) Continuation of application No. 16/411,889, filed on May 14, 2019, now abandoned.
(60) Provisional application No. 62/670,942, filed on May 14, 2018.

(51) Int. Cl. F16K 41/16; F16K 11/085; F16K 1/48

(52) U.S. Cl. CPC F16K 41/16; F16K 1/485; F16K 11/0856

(57) ABSTRACT

A plug valve having a modular construction. The valve has a solid, single-piece body with two opposed openings interrupted by an internal chamber. The chamber houses a rotatable plug which selectively restricts or allows flow from one of the two openings to the other. Inserts partially surround the plug and have openings that corresponds to openings in the valve body and the plug. A seat with an end surface corresponding to each insert extends partially within each opening. A bolted-on flange extends from each side of the valve and has an internally placed sleeve which defines the flow path through the valve. The sleeve may seal against the seat at one of its ends. A non-planar groove may be formed in the end surface of each seat to seal the opening against each insert.

### SUMMARY

The present invention is directed to a valve. The valve comprises a single-piece body, a rotating plug, first and second inserts, and a first seat member. The body has opposed first and second openings and an internal chamber in communication with the openings. The plug is disposed within the chamber and has a fluid passage therethrough. The fluid passage is in communication with the first and second openings when in an open position. The inserts are disposed within the internal chamber and at least partially surround the rotating plug. Each insert has spaced inner and outer surfaces. A portion of the inner surface curves around the plug element. The first seat member is partially disposed within the first opening and extends into the internal chamber. The first seat member has an end surface disposed within the internal chamber and conforms to a portion of the first insert.

In another embodiment, the present invention is directed to a valve. The valve comprises a body, a first tube, a rotatable plug, at least two inserts, and a tubular adaptor. The body has an enlarged internal chamber and a first body passage that joins the chamber to an external surface. The first tube is removably received within the first body passage and has an internal surface. The plug is removably received within the chamber. Each insert has opposed inner and outer surfaces, the inner surface of each insert engaging and partially surrounding the plug. The adaptor comprises a first section and a second section. The first section has an external surface that conforms to the internal surface of the first tube. The second section is axially aligned with and offset from the first section. The second section is bounded in part by an external surface that conforms to the outer surface of each insert.

### BRIEF DESCRIPTION OF THE DRAWINGS

FIG. 1 is a perspective view of a plug valve as described herein.

FIG. 2 is a cross-sectional view of the plug valve of FIG. 1.

FIG. 3 is a perspective view of a valve having a sleeve attached by a plurality of connectors.

FIG. 4A is a top view of a rotatable plug for use with the valve of FIGS. 1-3.

FIG. 4B is a perspective view of the plug of FIG. 4A.

FIG. 4C is a side view thereof.

FIG. 4D is a front view thereof with the internal flow passage shown.

FIG. 5A is a top view of a sleeve for use with the valve of FIGS. 1-2.

FIG. 5B is a perspective view of the sleeve of FIG. 5A.

FIG. 5C is a front view thereof with the internal flow passage shown.

FIG. 5D is a side view thereof.

FIG. 6A is a top view of the inserts shown in the valve of FIG. 2.

FIG. 6B is a perspective view of the inserts of FIG. 6A.

FIG. 6C is a front view thereof with the internal flow passage shown.

FIG. 6D is a side view thereof.

FIG. 7A is a top view of a tubular adaptor or seat for use with the valve of FIGS. 1-3.

FIG. 7B is a perspective view of the seat shown in FIG. 7A.

FIG. 7C is a front view thereof with its inner secondary passage shown.

FIG. 7D is a side view thereof.

### DETAILED DESCRIPTION

Generally, a plug valve forms a flow passage and has a selectively operable closure to open or close the flow passage to control a flow of fluid through the valve. The seals of high pressure valves must withstand high operating fluid pressures. These could be 5,000 pounds per square inch (psi) and higher. In addition, they must do so while controlling the flow of corrosive and/or abrasive fluids. Fluids typically used in the oil and gas industry can erode internal valve components. Valves of this type are often subjected to working pressures of up to 22,500 pounds per square inch. The 5,000 psi number should only be considered a “floor”, below which conditions would not be considered “high pressure” in the hydraulic fracturing and oil and gas industries.

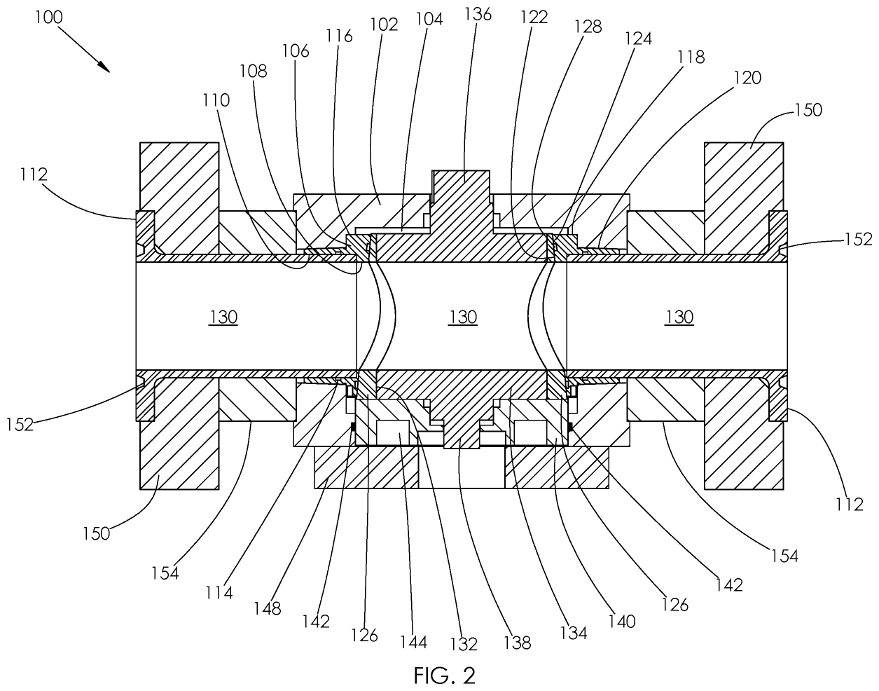

Fluid typically can flow either way through the body when the internal plug, such as plug 134 of FIG. 2, is rotated to the open position. In the open position, an internal opening 131 is aligned with the flow passage 130 of the valve 100 such that the inlet, outlet, and internal opening 131 of the plug 134 are in alignment and fluid communication. When the plug 134 is rotated ninety degrees to its closed position, the plug provides a barrier between the inlet and outlet portions of the flow passage and disrupts flow. The closed plug 134 seals against an inside diameter of each of a number of inserts 126. In a conventional plug valve an outside diameter of at least some of the inserts has a seal that seals against the bore. Each seal is supported in a groove formed in the outside diameter surface of the inserts. The plug valve body, plug, and insert have through passageways communicating with the bore to allow flow through the valve.

Fluid travelling through the valve is often a fracturing fluid or “frac” fluid. Such fluid is water-based, but includes additives that assist in the fracturing of a downhole formation. These additives may include acids, such as hydrochloric acid. They may also include corrosion or scale inhibitors. Finally, frac fluid often includes suspended “proppants”—often sand or silica—which is used to “prop” open fissures in downhole formations. Such proppants enable additives to reach deeper into formations in oil and gas operations.

Operating a valve at high pressure conditions with acidic fluid containing abrasive proppant material can cause erosion of the location where the seal in the insert contacts the bore, often resulting in leakage. This leakage may occur quickly and limit the life of the valve. Repairing the valve body, such as by a weld build-up and machining operation, is a cumbersome and disruptive repair in the oilfield.

For this reason, it is advantageous to transfer the wear from the valve body to smaller, replaceable parts like the aforementioned inserts. By transferring the seating location of the seal from the insert to the valve body, the wear associated with the seal is moved from the valve body to the insert.

As disclosed in U.S. Pat. No. 10,288,178 issued to Nowell, et al., the contents of which are incorporated herein by reference, the bore failure point has been eliminated by embedding the seal into a groove formed in the valve body instead of the inserts. This design transfers the wear to the replaceable inserts and protects the valve body.

When the wear is transferred from the valve body to the insert, the next wear point may become the inlet and outlet portions of the plug valve. Over time, erosion of these through passageways results in unacceptable wear to the plug valve. As plug valves are starting to last significantly longer because of moving the seal from the insert to the valve body, this wear point in the through passageways becomes more critical to valve integrity.

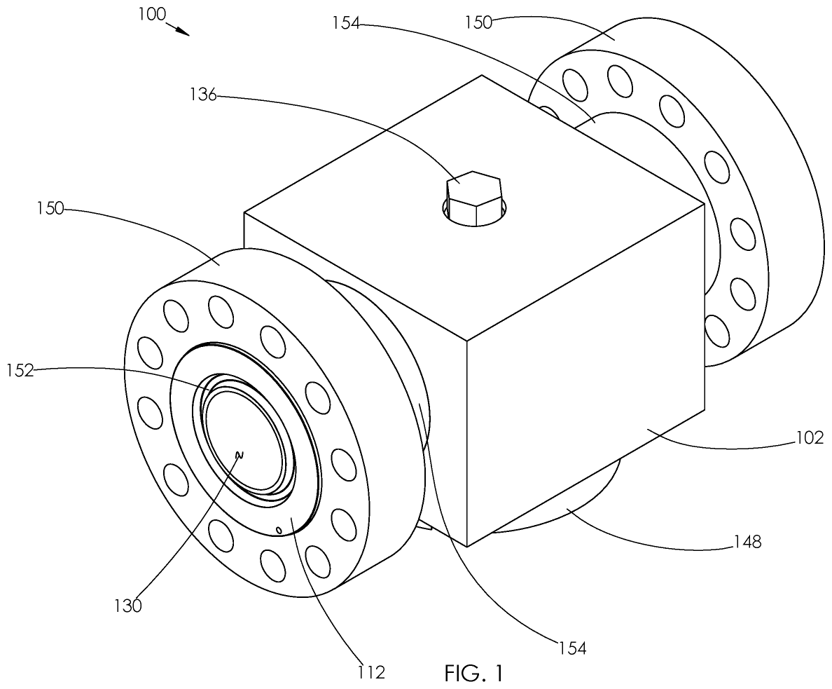

FIGS. 1-3 show a plug valve 100. The plug valve 100 has a forged valve body 102 forming an enlarged internal chamber 104. As shown, the internal chamber 104 is generally complementary to a cylinder. However, a cylinder with a taper, or conical frustum, or one with flat rectangular ends may be utilized for the internal bore. The external surface of the valve body 102 is generally a rectangular prism or cube. The valve body 102 is a single-piece construction.

Unless specifically stated otherwise all references to positional relationships are considered relative to the position of the internal chamber 104 of the valve body 102 when the plug valve 100 is in the assembled state, though the valve 100 is modular and contains replaceable parts.

The valve has first and second flow openings 130 which are interrupted by the internal chamber 104. The valve 100 comprises its body 102, seats 106, sleeves 112, a flange member 150, inserts 126, and a rotating plug 134. As shown, one seat 106 and one sleeve 112 extend into each of the first and second flow openings 130. One flange 150 is attached at each side of the valve 100.

Accordingly, both the inlet and outlet sides of the valve have a seat, sleeve, flange and insert in the embodiment of FIG. 2. Alternatively, some of these elements on one side or the other may be made integral with the valve body 102.

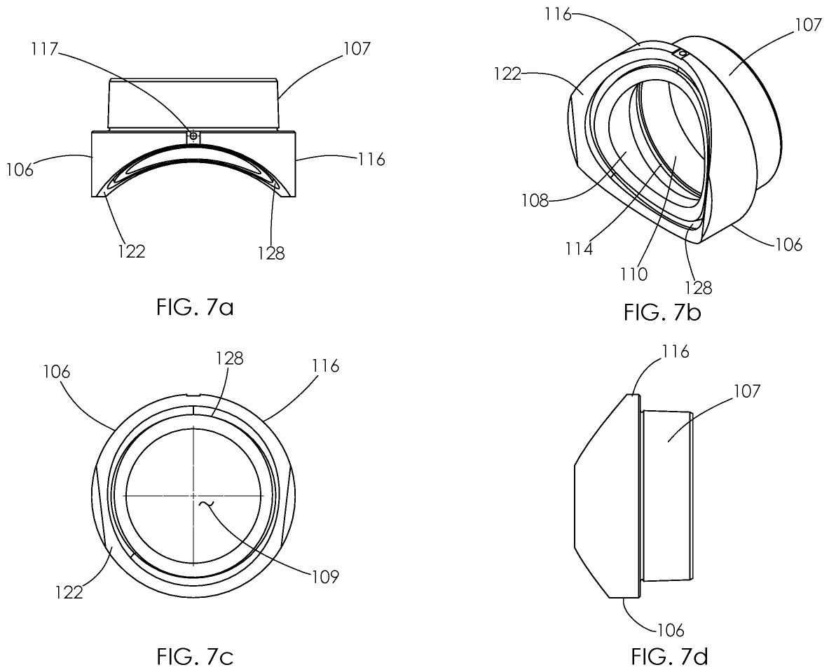

With reference to FIGS. 7A-7D, the seats 106 act as tubular adaptors that fit inside the openings of the valve body 102. The seats 106 contain first and second sections, and an inner passage 109 formed therethrough. The first section 107 has an internal surface that conforms to the external surface of a paired sleeve 112. The second section 116 has a larger outer diameter and contains an end surface 122 that abuts an adjacent insert 126 within the internal chamber 104. The inside surface 108 of the second section 116 of the seat 106 is sized to match the diameter of the flow passage 130.

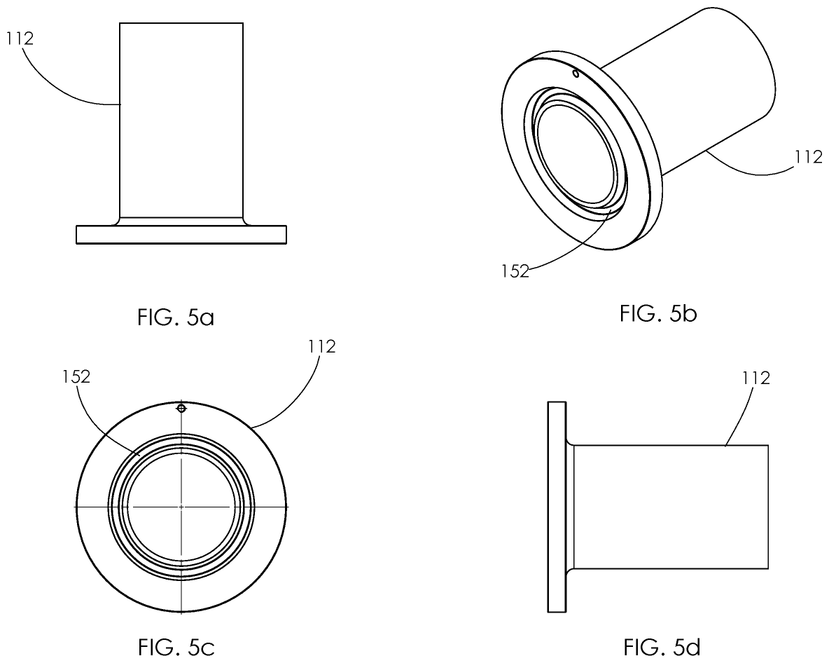

The inside surface 110 of the first section 107 may be counterbored to allow for retention and sealing of the sleeve 112 shown in FIGS. 2 and 5A-5D. In this way, the maximum cross-sectional dimension of the second section 116 is greater than that of the first section 107. A seal groove 114 may be formed in the inside surface 110 of the first section 107 to allow the installation of a radial seal (not shown) in the seat 106 to seal the joint between the seat 106 and sleeve 112. The seal groove 114 may instead be in the outside diameter of the sleeve 112. In this way, a portion of the inner passage 109 is coincident with the flow passage 130, and forms an inner secondary passage that can house both the flow passage 130 and the sleeve 112.

The second section 116 of the seat 106 may be sized to match a counterbore 118 in the valve body 102 which aligns the inner passage 109 of seat 106 to the flow passage 130. The seat 106 may also comprise a feature added to the seat 106 to facilitate removal from the valve body 102. As shown, the feature is a small hole 117 bored partially through the wall of the seat 106 in cooperation with a clearance area machined in the valve body 102 to allow the installation of a removal tool.

The first section 107 may be tapered to match a tapered bore 120 in the valve body 102 sealing the joint between the seat 106 and valve body 102. This seal could consist of ‘poly-pak’ seals or other seals.

The end surface 122 of the seat 106 is complimentary to an outer surface 124 of the insert 126. As shown, the outer surface 124 of the insert 126 is at least partially congruent to a surface of a tapered cylinder, or conical frustum. The center axis of the opening formed in the seat 106 and the insert 126 is parallel to the axis of flow. The end surface 122 may extend in transverse relationship to the center axis of the seat 106.

As shown, the end surface 122 may have a seal groove 128 formed in it to house a seal between the seat 106 and insert 126. The seal groove 128 and accompanying seal surround the central opening in the seat 106 and extends along a non-planar path. Seal groove 128 may have a bottom with parallel sides extending in a direction perpendicular from the bottom of the groove. The seal abuts these sides and the adjacent insert 126.

Alternatively, the seal could be mounted in the insert 126 or the seal could rely on metal to metal contact only.

Although two inserts 126 are depicted, the contemplated embodiments are not so limited because alternatively there can be one, or more than two. In embodiments with more than two inserts 126, there may be inserts without flow passages. The inserts with flow passages 130 through them may be identically shaped and sized. As shown, each insert 126 has an outer surface 124 congruent to a conical frustum forming a matching taper to engage against the seat 106 in a close mating relationship.

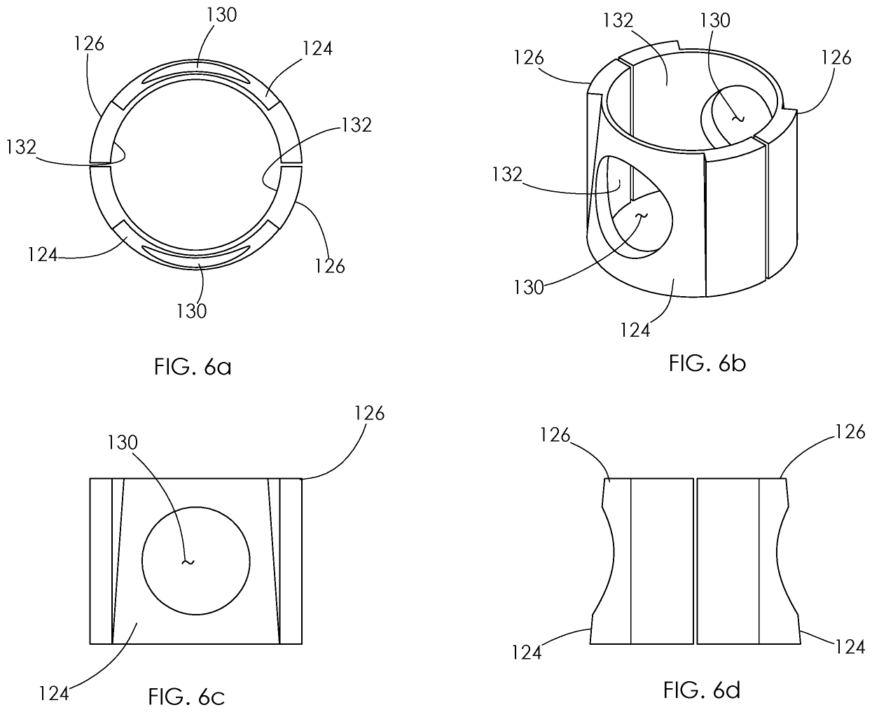

Each insert 126 is formed from a body having an inner surface and its spaced outer surface. As best shown in FIGS. 6a-6d, the inserts 126 may be ungrooved. The outer surface 124 should have a shape complementary to that of the end surface 122 of seat 106, without grooves or seals. As shown, the inner surface 132 is concave and engages and partially surrounds the outer surface of the plug 134.

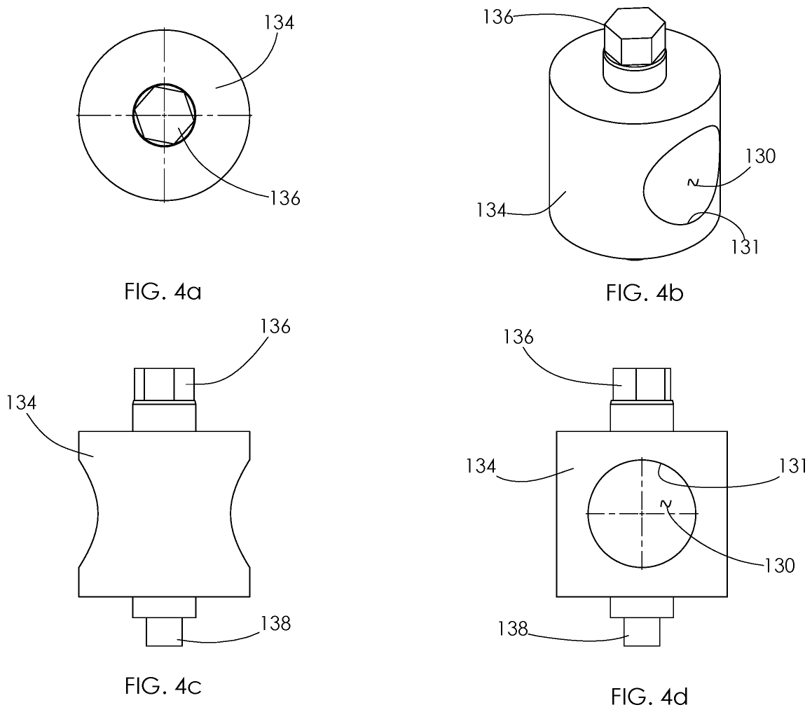

As best shown in FIGS. 4a-4d, the plug 134 has an outer surface sized to fill the space between the inserts 126 and forms a metal-to-metal seal with the inner surface 132 of the respective inserts 126. As shown the plug 134 is partially cylindrical, and at least a portion of its outer surface is congruent with a portion of the curved side of a cylinder. The plug 134 has a journal 136 that is rotatable by a handle (not shown). A seal (not shown) seals against the journal 136 to contain the pressurized fluid inside the valve 100 while permitting an external force to rotate the journal 136 and, in turn, the plug 134. Alternatively, the journal 136 can be rotated by a powered actuator. The plug 134 also has a second journal 138 that rotates within the seal cap 140.

Inserts 126 cooperate with and surround the plug 134. The flow opening 130 interconnects the inner 132 and outer surfaces 124 of the inserts 126. Thus, the inner surface 132 has a center of curvature coincident with the axis of rotation of the plug 134. Additionally, each insert 126 may have a center of curvature that it does not fully enclose.

The inserts 126 and rotatable plug 134 may be made from a durable metallic material, a ceramic material, or high-density plastic. Metallic materials may be the same or a different alloy than used in the valve body 102. Inserts 126 and the plug 134 being smaller and more simply formed than the valve body 102, are easier to treat. Inserts 126 and plug 134 can therefore be heat treated, treated with chemicals, or made with wear-resistant alloys in order to improve the life of the valve 100.

To enclose the plug 134 and support the second journal 138, a seal cap 140 may be installed in the valve body 102. The seal cap 140 seals to the internal chamber 104 by seal 142. The seal 142 may be situated in a groove formed either within the seal cap 140 or in the valve body 102. Although a radial seal is depicted, in alternative embodiments an axial seal or a crush seal and the like can be used instead of or in addition to the radial seal 142. The seal cap 140 may have a radial groove 144 in the distal face for retention of a spring in cooperation with the proximal face of the cover plate 148. The spring may be a conical spring, wave spring, or the like. The spring is to allow for easier alignment of the plug 134 and inserts 126 in the flow path.

To retain the seal cap 140 in place a cover plate 148 may be assembled to the valve body 102. The proximal face of the cover plate 148 may mount flush to the valve body 102 and to the proximal face of the seal cap 140 trapping the spring between the seal cap 140 and cover plate 148. The cover plate 148 may be assembled to the valve body 102 with threaded fasteners or by a threaded connection to the valve body 102.

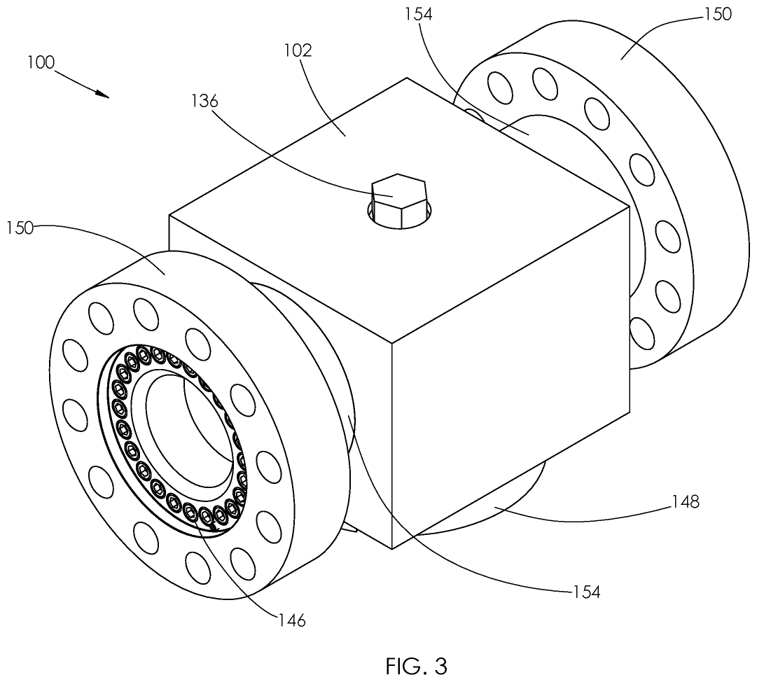

A flange 150 may be attached to the inlet and/or outlet of the valve body 102 to facilitate the connection of the valve 100 to other flow components. The flange 150 has a central passage alignable with the flow path 130 and the openings in the valve body 102. The flange 150 may be connected directly to the valve body 102 with threaded fasteners 146 (FIG. 3) or by threading the flange 150 directly to the valve body 102. The flanges 150 may also have integral or detachable spaced sections 154 to separate the flanges 150 different distances from the valve body 102 if desired.

The outer surface of the flange may have any connection type necessary for connection to other flow control components. A standard bolt circle is shown in this embodiment. The flange 150 may be of any convenient length to facilitate use in operation with different lengths able to be used on each of the inlet and outlet ports. The connection type at the distal end may also be different at each of the inlet and outlet ports.

The sleeve 112 is inserted in the flange 150 to provide a tube with a central flow passage within which the flow path 130 for the fluid controlled by the valve 100 is located. One end of the sleeve 112 inserts into the distal end of the seat 106 and is sealed as described previously. The opposite end of the sleeve 112 may be located in the correct position by the mating of a shoulder on the sleeve 112 to the face of a counterbore machined in the distal face of the flange 150. A seal groove 152 or the like may be machined in the distal face of the sleeve 112 to provide a sealing function to the attached flow control component. Detail of the sleeve 112 is shown in FIGS. 5A-5D.

In this valve 100 the entire flow path is made up of replaceable components. When erosion or corrosion occurs in any area of the flow path the compromised component may be replaced without requiring the currently standard repair procedure of adding new material to the eroded or corroded area by welding then machining the added material back to the original design. Additionally, the modular aspect of the components results in a total cost reduction. The ability to attach the flanges 150 separately allow the single-piece, forged valve body 102 to be smaller using less material and simplifying the machining process. Use of the seats 106 to attach the sleeves 112 greatly reduces the likelihood of a full pressure jet of fluid impacting the valve body 102 due to a seal failure or the high-pressure jets produced as the plug 134 is cracked open. Instead the seat 106 will be damaged and is easily replaceable.

Various modifications can be made in the design and operation of the present invention without departing from the spirit thereof. Thus, while the principle preferred construction and modes of operation of the invention have been explained in what is now considered to represent its best embodiments, which have been illustrated and described, it should be understood that the invention may be practiced otherwise than as specifically illustrated and described.

1. A valve, comprising:
a body having:
a passage that traverses the body; and
an internal chamber that interrupts the passage;
a flow disrupting element disposed within the internal chamber and configured to selectively block the passage;
a flange attached to the body, the flange having:
an elongate channel extending therethrough, the channel in fluid communication with the passage and having a longitudinal axis; and
an end surface, in which the end surface is congruent to a first plane which is substantially perpendicular to the longitudinal axis;
a removable sleeve disposed in the flange, the sleeve having:
a first surface parallel to the first plane, the first surface being interrupted by an endless groove; and
an internally-disposed surface exposed to the passage.

2. The valve of claim 1 further comprising a seal disposed within the endless groove.

3. The valve of claim 1 in which the flange is removably attached to the body.

4. The valve of claim 3 in which the sleeve is configured to extend from a central opening of the flange into the internal chamber of the body.

5. The valve of claim 1, further comprising an insert disposed within the internal chamber and at least partially surrounding the flow interrupting element, in which the insert has an external surface, a portion of which is congruent with a portion of the curved side of a cone.

6. The valve of claim 5 further comprising:
a seat member partially disposed within the passage and extending into the internal chamber, the seat member having an end surface disposed within the internal chamber and conforming to a portion of the first insert.

7. The valve of claim 6 further comprising a seal positionable within the endless groove of the sleeve.

8. The valve of claim 5 in which the insert is characterized as a first insert and the seat member is characterized as a first seat member, further comprising:
a second insert disposed within the internal chamber and at least partially surrounding the flow interrupting element; and
a second seat member partially disposed within the passage and extending into the internal chamber, the second seat member disposed on an opposite side of the plug from the first seat member and further comprising:
a tubular portion extending into the passage and forming an inner secondary passage therethrough;
an end surface disposed within the internal chamber; and
a groove formed in the end surface and surrounding the inner secondary passage following a non-planar path.

9. The valve of claim 1 in which the flow interrupting element is a rotatable cylindrical plug.

10. A system comprising:
the valve of claim 9; and
a high-pressure fluid within the valve.

11. The system of claim 10 in which the high pressure fluid is subject to a pressure of greater than five thousand pounds per square inch.

12. A valve, comprising:
a single-piece body, having opposed first and second openings and an internal chamber that is in communication with the first and second openings;
a flow interruption element disposed within the internal chamber and having a fluid passage extended therethrough, in which the fluid passage communicates with the first and second openings when in an open position and does not communicate with the first and second openings when in a closed position;
a first flange extending from the single-piece body, the first flange comprising:
an elongate channel in communication with the first opening, the elongate channel defining a longitudinal axis; and
a first sleeve at least partially disposed in the first flange, the first sleeve having:
a first surface which is substantially perpendicular to the longitudinal axis; and
an endless groove, in which the endless groove interrupts the first surface.

13. The valve of claim 12, further comprising:
a second flange extending from the single-piece body, the second flange comprising:
an elongate channel in communication with the second opening, the elongate channel defining a longitudinal axis; and
a second sleeve at least partially disposed in the second flange, the second sleeve having:
a second surface which is substantially perpendicular to the longitudinal axis; and
an endless groove, in which the endless groove interrupts the first surface.

14. The valve of claim 13 in which the first and second flange each define radially-displaced connection points.

15. The valve of claim 12 in which the flow interruption element is a rotatable plug.
